(19) United States
(12) Patent Application Publication
(10) Pub. No.: US 2006/0224916 A1
(43) Pub. Date: Oct. 5, 2006

(54) Data storage device, reconstruction controlling device, reconstruction controlling method, and storage medium

(76) Inventor: Takeshi Makita, Kanagawa (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 11/396,871

(22) Filed: Apr. 3, 2006

(30) Foreign Application Priority Data
Apr. 4, 2005 (JP) P2005-106964

(51) Int. Cl. G06F 11/00

(52) U.S. Cl. 714/6

(57) ABSTRACT

A data storage device having a redundant storage area for processing data, the data storage device including an input-output state determining unit for determining whether a command process involved in one of input and output of processing data from and to an outside of the device is being performed or waiting to be performed, a reconstruction request determining unit for determining whether there is a request for a process of reconstructing stored data which process accompanies replacement of a faulty part, and a reconstruction process performing unit for giving an instruction to execute a reconstruction command when the input-output state determining unit determines that the command process involved in one of input and output of processing data from and to the outside of the device is not being performed nor waiting to be performed, and when the reconstruction request determining unit determines that there is a request for the process of reconstructing stored data which process accompanies replacement of a faulty part.

### CROSS REFERENCES TO RELATED APPLICATIONS

The present invention contains subject matter related to Japanese Patent Application P2005-106964 filed with the Japanese Patent Office on Apr. 4, 2005, the entire contents of which being incorporated herein by reference.

### BACKGROUND OF THE INVENTION

One form of the present invention relates to a data storage device having a redundant storage area for processing data.

Another form of the present invention relates to a reconstruction controlling device that controls an operation of reconstructing stored data in the above-described data storage device.

Another form of the present invention relates to a reconstruction controlling method that controls an operation of reconstructing stored data in the above-described data storage device.

Another form of the present invention relates to a storage medium for storing a program that implements an operation of reconstructing stored data in the above-described data storage device.

A data storage device handing a large amount of digital data on a daily basis uses a processing technique that can read and write processing data at high speed and a processing technique that enhances availability.

For example, the processing technique that can read and write processing data at high speed uses a striping system. The striping system refers to a technical method that divides one piece of processing data into a plurality of processing units and simultaneously reads or writes these processing units on a plurality of storage media arranged in parallel with each other.

For example, the processing technique that enhances availability uses a redundant data storing system. One example of the redundant data storing system is a method of storing error correcting code (parity code) used for error correction or restoration of processing data. Another example is a method referred to as mirroring.

Currently mainstream storage media of high-capacity storage devices are magnetic storage media (hard disks).

The above-described data storage device is therefore referred to also as a disk array device. Incidentally, a technology that enhances the availability of a disk array technology is referred to as RAID (Redundant Arrays of Inexpensive Disks). Examples of applications for disk array devices by the applicant are shown in Patent Document 1 and 2 (see Japanese Patent Laid-open No. 2000-66845 as Patent Document 1, and Japanese Patent Laid-open No. Hei 11-45158 as Patent Document 2).

### SUMMARY OF THE INVENTION

Some fault may occur in a storage medium storing processing data and redundant data during operation of a disk array device. In this case, it is necessary to isolate the storage medium in which the fault has occurred from the system and replace the storage medium. For this replacement, there are a method that physically isolates the storage medium in which the fault has occurred from the disk array device and physically connects a new storage medium, and a method that logically isolates the storage medium in which the fault has occurred from the disk array device and logically connects an auxiliary storage medium incorporated in advance.

In both the systems, stored data stored on the storage medium before the replacement needs to be reconstructed on the storage medium after the replacement.

An existing disk array device incorporates a function of controlling this reconstruction process.

FIG. 1 shows an image of a process when a reconstruction command is forcefully executed at a ratio of one reconstruction command to four processing data input/output commands (read commands/write commands).

FIG. 1 shows an example of input/output commands being generated continuously. A reconstruction command executed forcefully at the constant ratio causes a delay in execution of the input/output commands. This delay presents no problem when processing data read or written at an input/output command requires a low degree of real-time capability.

However, a problem of a delay caused in the original process is presented when handling processing data requiring a high degree of real-time capability, such as video data and audio data (voice data, musical piece data and other sound data). In addition, this delay accumulates. The same is true for processing data having a large data size.

Accordingly, there is a method that sets a rate of execution of reconstruction commands to zero as shown in FIG. 2 when handling processing data requiring a high degree of real-time capability. Input/output commands are not delayed in this case.

However, since the rate of execution of reconstruction commands is set to zero, the method represented in FIG. 2 cannot execute reconstruction commands at all even when there are no input/output commands.

In addition, as illustrated in FIG. 3, there is a method that forcefully executes a reconstruction command in a fixed time. Also in this case, when an input/output command and a reconstruction command overlap with each other, the reconstruction command is forcefully executed.

Therefore, input/output commands can be delayed when processing data requiring a high degree of real-time capability is handled. On the other hand, the method of executing a reconstruction command in a fixed time can execute a reconstruction command in an available time free from input/output commands. It is thus possible to make use of the available time and reduce the number of times that an input/output command is delayed.

However, the method represented in FIG. 3 does not make effective use of the available time, and is slow in the progress of reconstruction of stored data.

The inventor has directed attention to the above technical problems, and proposes a technique having the following processing functions.

(1) A process of determining whether a command process involved in one of input and output of processing data from and to an outside of a device is being performed or waiting to be performed

(2) A process of determining whether there is a request for a process of reconstructing stored data which process accompanies replacement of a faulty part

(3) A process of giving an instruction to execute a reconstruction command when it is determined that the command process involved in one of input and output of processing data from and to the outside of the device is not being performed nor waiting to be performed, and when it is determined that there is a request for the process of reconstructing stored data which process accompanies replacement of a faulty part.

In this case, no reconstruction command is executed while a command process involved in the input or output is being performed or waiting to be performed. On the other hand, a reconstruction command is executed when the command process involved in the input or output is not being performed nor waiting to be performed.

It is to be noted that these processing functions may be implemented as software processing or may be implemented as hardware processing. In addition, a part of the processes may be implemented by software processing and a remaining part may be implemented by hardware processing.

By employing the technique according to an embodiment of the present invention, even when the reconstruction process is requested, the performance of the command process involved in the input or output of processing data from and to the outside of the device can be given priority while the command process involved in the input or output is being performed or waiting to be performed. On the other hand, the reconstruction process can be performed intensively while the command process involved in the input or output is not being performed nor waiting to be performed.

It is thereby possible to effectively avoid a delay in executing a command involved in input or output, and reduce a time required for the reconstruction process.

### BRIEF DESCRIPTION OF THE DRAWINGS

FIG. 1 is a diagram illustrating a conventional example of a stored data reconstruction processing technique;

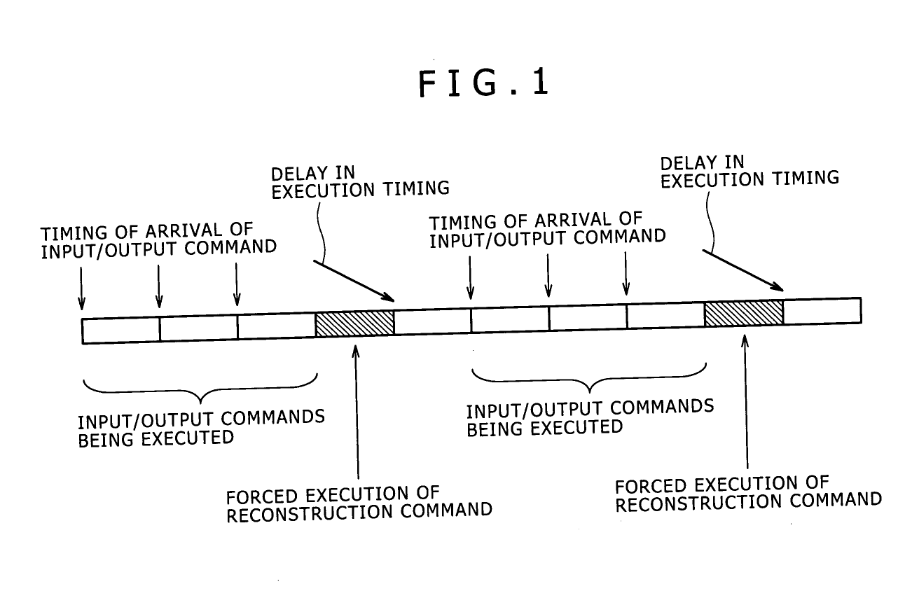

FIG. 2 is a diagram illustrating the conventional example of the stored data reconstruction processing technique;

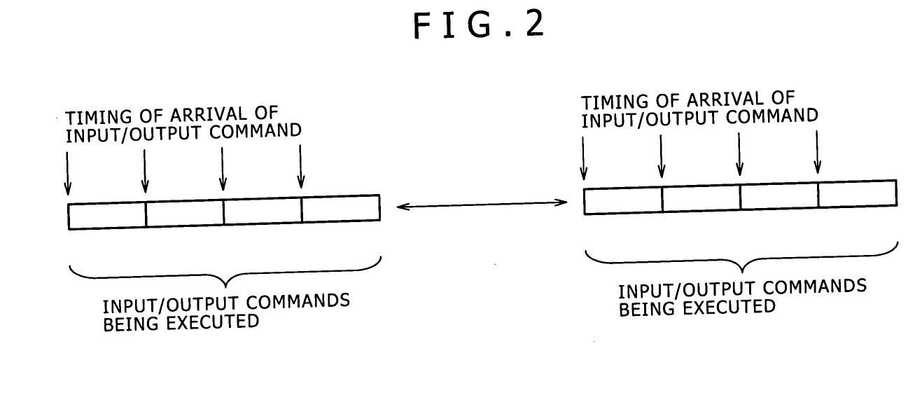

FIG. 3 is a diagram illustrating the conventional example of the stored data reconstruction processing technique;

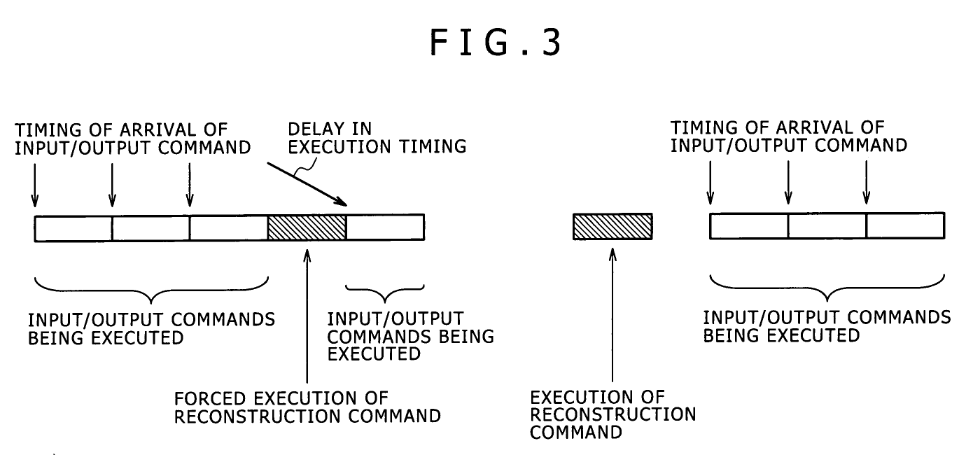

FIG. 4 is a diagram showing an example of configuration of a server system;

FIG. 5 is a diagram showing an example of internal configuration of a file server;

FIG. 6 is a diagram showing a conceptual configuration of a data storage;

FIG. 7 is a diagram showing an example of hardware configuration of the data storage;

FIG. 8 is a diagram showing an example of functional configuration of a reconstruction control device;

FIG. 9 is a diagram showing an example of a process procedure of a reconstruction process function; and

FIG. 10 is a diagram illustrating an embodiment of a stored data reconstruction processing technique.

### DETAILED DESCRIPTION OF THE PREFERRED EMBODIMENTS

An embodiment of a data storage device employing a technical method according to the present invention will hereinafter be described.

Incidentally, techniques well known or publicly known in a pertinent technical field are applied to parts not specifically shown or described in the present specification.

The embodiment to be described below is one embodiment of the present invention, and therefore the present invention is not limited thereto.

(A) Server System

(A-1) System Configuration

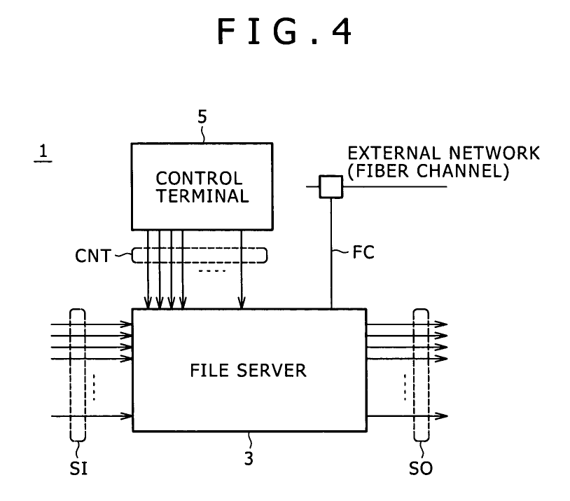

FIG. 4 shows an example of configuration of a server system 1. The server system 1 includes a file server 3 and a control terminal 5.

The file server 3 refers to a computer that shares a data storage device (data storage) managed by the computer itself with another terminal in the system and thus allows external use of the data storage device. Of course, details of internal configuration of the file server 3 differ depending on the nature of work to which the file server 3 is applied and purposes thereof. The file server 3 in FIG. 4 has two input-output interfaces.

The two input-output interfaces are an interface handling input and output data SI and SO and an interface handling input and output data FC.

The control terminal 5 is a computer that controls the internal operation of the file server 3.

(A-2) File Server

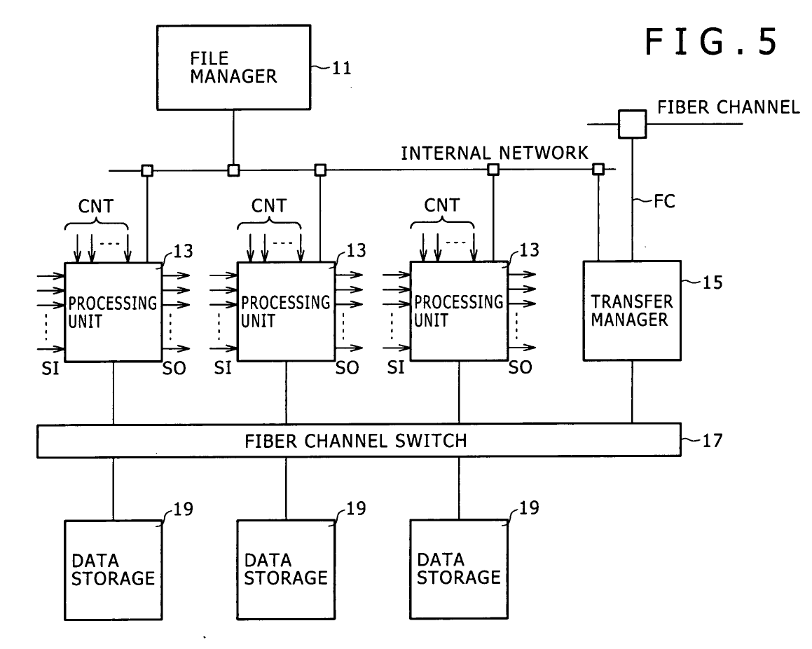

FIG. 5 shows an example of internal configuration of the file server 3. Incidentally, FIG. 5 shows a case where processing data handled by the system is video data and audio data. That is, FIG. 5 shows a case where the file server 3 is a so-called AV server. In the case of FIG. 5, AV data is input and output from and to a separate external device through serial data interfaces SI and SO and a fiber channel interface FC.

The file server 3 includes a file manager 11, processing units 13, a transfer manager 15, a fiber channel switch 17, and data storages 19.

The file manager 11 is a computer that manages the input and output of AV data within the server.

The processing units 13 are devices that encode and decode the AV data. The processing units 13 are formed by an existing processing board or card, for example. The processing units 13 are supplied with AV data from not only the serial data interface SI but also the fiber channel interface FC. Similarly, processed AV data is output from not only the serial data interface SO but also the fiber channel interface FC. Incidentally, the processing operation of the processing units 13 is controlled by a control signal CNT supplied from the control terminal 5.

The transfer manager 15 is a computer that manages the input and output of AV data between the file server 3 and the fiber channel interface FC as an external network.

The fiber channel switch 17 is a device for relaying AV data transmitted through a fiber channel as an internal channel. Incidentally, the fiber channel as the internal channel is connected with the processing units 13, the transfer manager 15, and the data storages 19.

The data storages 19 are a data storage device used to store AV data. The data storages 19 correspond to a data storage device in claims. The data storages 19 use a disk array device having an error correcting function. In the present embodiment, description will be made of a case where error correcting code is used as redundant data.

(A-3) Data Storage

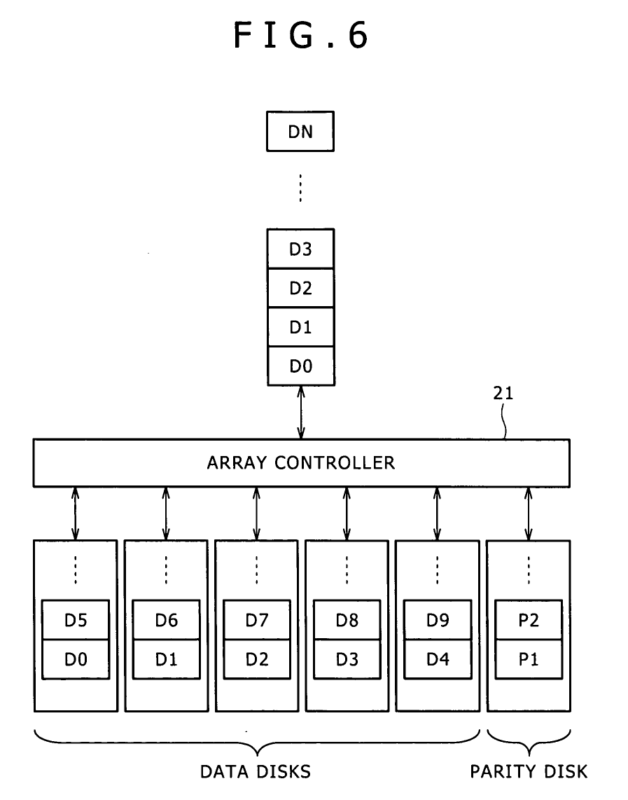

Details of configuration of the data storages 19 will be described. FIG. 6 shows a conceptual configuration of a RAID-3 type data storage 19. In this conceptual configuration, the data storage 19 includes an array controller 21, five data disk devices, and one parity disk device. Specifically, the data storage 19 includes six hard disk devices.

The array controller 21 performs a process of dividing input data (processing data) into a plurality of processing units D0, D1, . . . and DN and then writing the data to the five data disks in a parallel manner, and a process of reading and combining the corresponding processing units D0, D1, . . . and DN from the five data disks, and outputting the processing units D0, D1, . . . and DN as output data (processing data).

This dividing process is referred to as striping. Incidentally, the array controller 21 generates error correcting code (parity data) at the time of the dividing process. The error correcting code is not only referred to at a time of reading processing data to be used to correct errors of output data, but also used to reconstruct stored data at a time of replacing a faulty disk. In FIG. 6, a fixed parity disk is used.

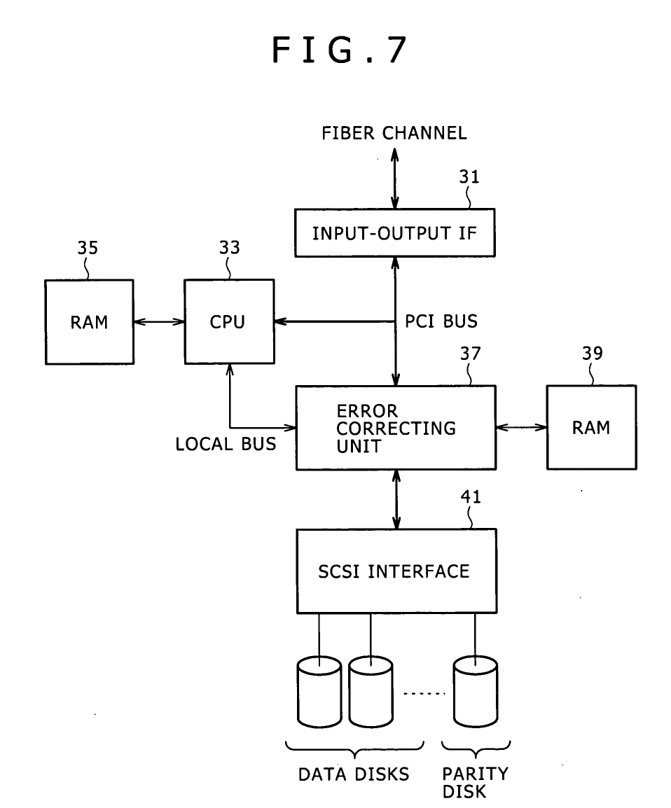

FIG. 7 shows an example of hardware configuration of the data storage 19. The data storage 19 includes an input-output interface 31, a CPU 33, a RAM 35, an error correcting unit 37, a RAM 39, and a SCSI interface 41.

The input-output interface 31 connects the data storage 19 to the fiber channel.

The CPU 33 is a computer that controls the operation of the data storage 19. Functions provided by the CPU 33 are implemented via a program. For example, processes of writing and reading processing data and a process of reconstructing stored data which process is involved in replacing a faulty disk are implemented.

The RAM 35 is a storage area for storing a command (input-output command) accompanying the input and output of processing data given from the file manager 11. That is, the RAM 35 functions as a command queue.

The error correcting unit 37 is a processing device that performs a processing data switching process and a process of generating error correcting code and performing error correction. Incidentally, a destination to which to output processing data (processing unit) is changed by a matrix switch included in the error correcting unit 37.

For example, at a time of writing input data, the matrix switch attaches error correcting code to the processing data input from the input-output interface 31, and then outputs the processing data to the RAM 39. Thereafter, the matrix switch outputs the processing data read from the RAM 39 to the SCSI interface 41.

For example, at a time of reading output data, the matrix switch subjects the processing data input from the SCSI interface 41 to error correction, and then outputs the processing data to the RAM 39. Thereafter, the matrix switch outputs the processing data read from the RAM 39 to the input-output interface 31.

For example, at a time of reconstructing stored data, the matrix switch outputs the processing data input from the SCSI interface 41 to the RAM 39. Next, the matrix switch reconstructs the stored data from the processing data read from the RAM 39, and then outputs the reconstructed stored data to the RAM 39. Thereafter the matrix switch outputs the processing data read from the RAM 39 to the SCSI interface 41.

The RAM 39 is used as a work area for this error correcting process.

The SCSI interface 41 performs a process of dividing processing data and a process of combining processing data between the SCSI interface 41 and the plurality of disk devices. A SAS (Serial Attached SCSI) is used for the SCSI interface 41, for example.

The error correcting unit 37, the RAM 39, and the SCSI interface 41 in FIG. 7 correspond to the array controller 21 in FIG. 6.

(B) Reconstructing Process Function

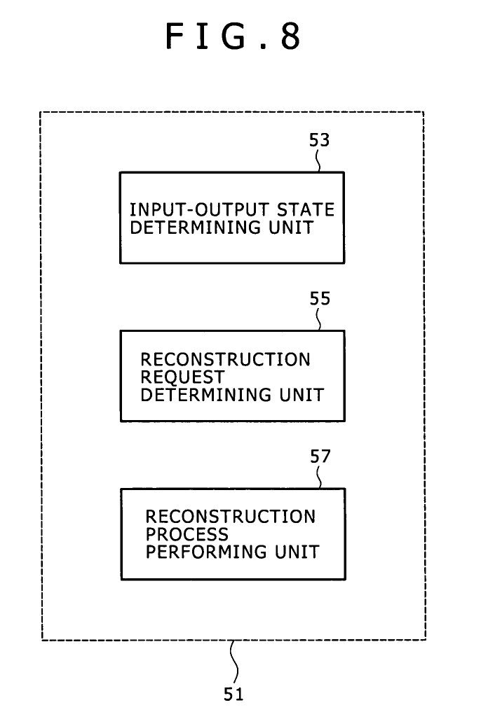

FIG. 8 shows an example of functional configuration of a reconstruction control device 51 implemented by the CPU 33. This functional configuration is implemented through program processing.

The reconstruction control device 51 includes an input-output state determining unit 53, a reconstruction request determining unit 55, and a reconstruction process performing unit 57.

The input-output state determining unit 53 is a processing function of determining that an input/output command is being executed or waiting to be executed. The input-output state determining unit 53 monitors the command queue (RAM 35) to determine whether there is an input/output command.

When there is an input/output command, the input-output state determining unit 53 determines whether the input/output command is being executed or waiting to be executed. Incidentally, the input/output command stored in the command queue is erased by another process performed by the CPU 33 at a time of receiving a notification of completion of the command process.

The reconstruction request determining unit 55 determines whether there is a request for (starting) a process of reconstructing stored data which process accompanies replacement of a faulty part. The request for the reconstructing process is generated on the basis of disk device fault detection.

Of course, a condition for requesting the reconstructing process is arbitrary. For example, the reconstructing process may be requested when a fault is detected in a single disk device, whereas the reconstructing process may be requested when a fault is detected in a plurality of disk devices. The latter is used when an auxiliary disk device is included.

The reconstruction process performing unit 57 gives an instruction to execute a reconstruction command when the input-output state determining unit 53 determines that no input/output command is being executed or waiting to be executed and when the reconstruction request determining unit 55 determines that there is a request for the reconstructing process.

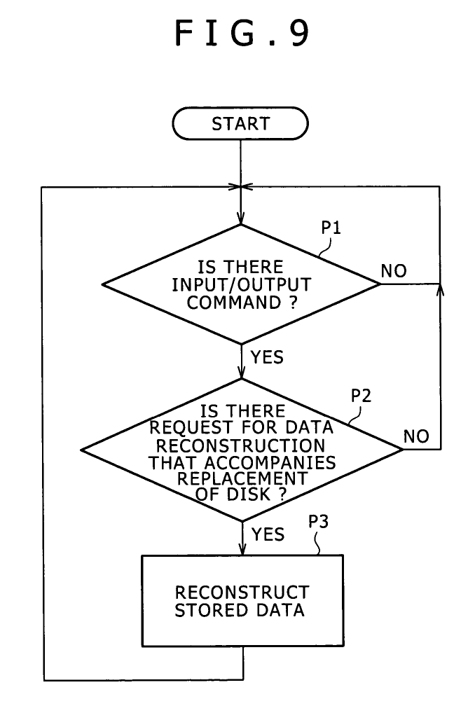

FIG. 9 shows an example of a process procedure related to the reconstruction process function of the disk array device. This reconstruction process function is implemented by a program that is resident in the CPU 33.

This program determines whether a command process involved in input or output of processing data from or to the outside of the data storage 19 (that is, the outside of the device) is being performed or waiting to be performed (P1). As described above, the program makes the determination on the basis of whether there is an input/output command in the command queue.

The program gives priority to input/output commands over a reconstruction command. Hence, when input/output commands are present in the command queue, the determining process of process P1 is repeated.

When the command queue becomes empty (that is, when there is no input/output command), on the other hand, the program determines whether a process of reconstructing stored data which process accompanies replacement of a disk device is requested (P2).

When the generation of a reconstruction command is not requested, the program returns to a state of monitoring the command queue.

When the generation of a reconstruction command is requested, on the other hand, the program generates a reconstruction command (P3). That is, the program registers the reconstruction command in the command queue, and thereby gives an instruction to execute the reconstruction command.

Thus, a process of reading data (processing units) necessary to reconstruct stored data, a process of data reconstruction using error correcting code, and a process of writing reconstructed data (processing units) are performed. A period from the reading of the data to the writing of the reconstructed data is one command period.

When the processes are started on the basis of the reconstruction command, the program returns to a state of determining whether there is an input/output command in the command queue, and thus repeats the above series of operations.

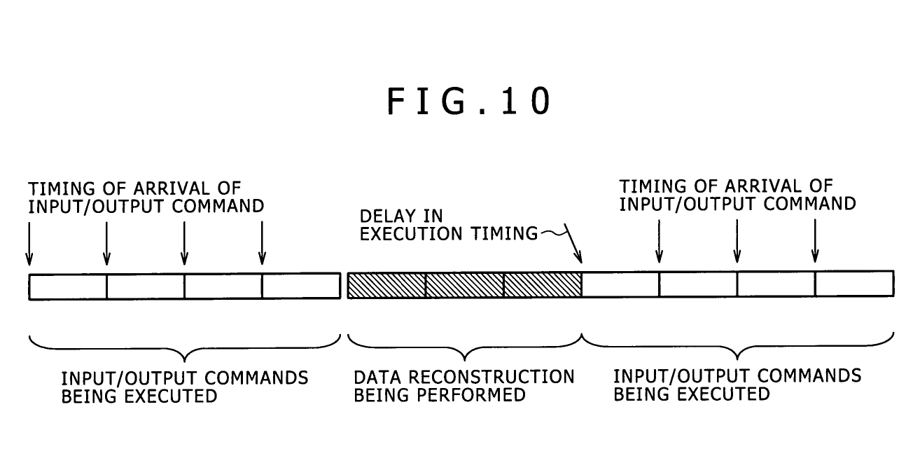

FIG. 10 shows an image of the command process implemented by the program illustrated in FIG. 9.

As shown in FIG. 10, while there is an input/output command, a process of writing processing data or a process of reading processing data which process accompanies the input/output command is performed preferentially, and a reconstruction command waits to be executed. Thus, delay in the execution of the input/output command is eliminated during the waiting of the reconstruction command.

On the other hand, while there is no input/output command, reconstruction commands are executed intensively. That is, reconstruction commands can be performed consecutively during an available time during which there is no input/output command. As a result, delay in data reconstruction as in the conventional art can be minimized.

Incidentally, when an input/output command is registered in the command queue while a reconstruction command is being executed (before the reconstruction command is removed from the command queue as a result of completion of the process), the input/output command is delayed only in a time before the completion of the process of the reconstruction command. An effective delay time, however, is shorter than a delay time attendant on forceful data reconstruction. Incidentally, this delay time can be reset at each time of interruption of input/output commands.

(C) Effects

As described above, the use of the reconstruction technique according to the present embodiment makes it possible to accelerate the progress of a stored data reconstruction process while minimizing delay in executing an input/output command.

The present invention is therefore suitable for data storages handling processing data of a large data size and processing data requiring a high level of real-time capability. For example, the present invention is suitable for data storages handing AV data.

(D) Other Embodiments

(a) In the foregoing embodiment, description has been made of a case where a data storage is formed by a disk array device of the RAID-3 type. That is, description has been made of a case where processing data is divided into byte units (processing units) and a data storage is formed by a disk array device provided with a fixed parity disk device.

However, the data storage may be formed by disk array devices of other RAID types.

For example, the data storage may be formed by a disk array device of a RAID-4 type. In this case, processing data is divided into block units (processing units). A disk array device of the RAID-4 type is the same as that of the RAID-3 type in that a fixed parity disk device is used.

Further, the data storage may be formed by a disk array device of a RAID-5 type, for example. In this case, a disk device functioning as a parity disk device is shifted in block units.

Further, the present invention is widely applicable to disk array devices having redundancy, such for example as a RAID-1 (mirroring) type, a RAID 1+0 (mirroring+striping), and other types. That is, the present invention is widely applicable to disk array devices having a redundant storage area.

(b) In the foregoing embodiment, description has been made of a case where a disk array device is formed by five disk array devices and one parity disk device.

However, the number of disk devices forming the disk array device is not limited to this.

(c) In the foregoing embodiment, description has been made of a case where a magnetic disk device (so-called hard disk device) is used as a storage medium forming a data storage device.

However, other kinds of storage medium may be applied to the storage medium forming the data storage device. For example, semiconductor memories may be used in a state of being arranged in the form of an array. This configuration enables data input and output at higher speeds.

(d) In the foregoing embodiment, description has been made of a case where a fiber channel interface FC is used to transmit and receive processing data.

However, other LAN interfaces may be used.

(e) In the foregoing embodiment, description has been made of a file server connected to a fiber channel. That is, description has been made of a large-sized storage system including a plurality of data storages as shown in FIG. 5.

However, the present invention is similarly applicable to storage systems including one data storage. Incidentally, the storage system is applicable not only to systems for business use including for example data storage servers for broadcasting service, data distribution service, communication service, medical data servers, administrative agencies, research institutes, companies and the like but also to systems used by individuals or in households.

(f) Various modifications of the foregoing embodiment can be considered within the scope of the spirit of the present invention. In addition, various modifications and applications created on the basis of the description in the present specification can be considered.

It should be understood by those skilled in the art that various modifications, combinations, sub-combinations and alterations may occur depending on design requirements and other factors insofar as they are within the scope of the appended claims or the equivalents thereof.

What is claimed is:

1. A data storage device having a redundant storage area for processing data, said data storage device comprising:
an input-output state determining unit for determining whether a command process involved in one of input and output of processing data from and to an outside of the device is being performed or waiting to be performed;
a reconstruction request determining unit for determining whether there is a request for a process of reconstructing stored data which process accompanies replacement of a faulty part; and
a reconstruction process performing unit for giving an instruction to execute a reconstruction command when said input-output state determining unit determines that the command process involved in one of input and output of processing data from and to the outside of the device is not being performed nor waiting to be performed, and when said reconstruction request determining unit determines that there is a request for the process of reconstructing stored data which process accompanies replacement of a faulty part.

2. The data storage device as claimed in claim 1,
wherein said processing data is data of a large data size.

3. The data storage device as claimed in claim 1,
wherein said processing data is data requiring a high degree of real-time capability.

4. A data storage device having a data processing section for reading and writing a plurality of processing units obtained by dividing one piece of processing data in parallel with each other between the data processing unit and a plurality of storage media, and a data processing unit for reading and writing redundant data used in restoring the processing data, said data storage device comprising:
an input-output state determining unit for determining whether a command process involved in one of input and output of processing data from and to an outside of the device is being performed or waiting to be performed;
a reconstruction request determining unit for determining whether there is a request for a process of reconstructing stored data which process accompanies replacement of a faulty part; and
a reconstruction process performing unit for giving an instruction to execute a reconstruction command when said input-output state determining unit determines that the command process involved in one of input and output of processing data from and to the outside of the device is not being performed nor waiting to be performed, and when said reconstruction request determining unit determines that there is a request for the process of reconstructing stored data which process accompanies replacement of a faulty part.

5. A reconstruction controlling device for controlling an operation of reconstructing stored data in a data storage device having a redundant storage area for processing data, said reconstruction controlling device comprising:
an input-output state determining unit for determining whether a command process involved in one of input and output of processing data from and to an outside of the device is being performed or waiting to be performed;
a reconstruction request determining unit for determining whether there is a request for a process of reconstructing stored data which process accompanies replacement of a faulty part; and
a reconstruction process performing unit for giving an instruction to execute a reconstruction command when said input-output state determining unit determines that the command process involved in one of input and output of processing data from and to the outside of the device is not being performed nor waiting to be performed, and when said reconstruction request determining unit determines that there is a request for the process of reconstructing stored data which process accompanies replacement of a faulty part.

6. The reconstruction controlling device as claimed in claim 5,
wherein said processing data is data of a large data size.

7. The reconstruction controlling device as claimed in claim 5,
wherein said processing data is data requiring a high degree of real-time capability.

8. A reconstruction controlling method for controlling an operation of reconstructing stored data in a data storage device having a redundant storage area for processing data, said reconstruction controlling method comprising:
a step of determining whether a command process involved in one of input and output of processing data from and to an outside of the device is being performed or waiting to be performed;
a step of determining whether there is a request for a process of reconstructing stored data which process accompanies replacement of a faulty part; and
a step of giving an instruction to execute a reconstruction command when it is determined that the command process involved in one of input and output of processing data from and to the outside of the device is not being performed nor waiting to be performed, and when it is determined that there is a request for the process of reconstructing stored data which process accompanies replacement of a faulty part.

9. A storage medium on which a program is recorded, said program making a computer for controlling a processing operation of a data storage device having a redundant storage area for processing data perform:
a step of determining whether a command process involved in one of input and output of processing data from and to an outside of the device is being performed or waiting to be performed;
a step of determining whether there is a request for a process of reconstructing stored data which process accompanies replacement of a faulty part; and
a step of giving an instruction to execute a reconstruction command when it is determined that the command process involved in one of input and output of processing data from and to the outside of the device is not being performed nor waiting to be performed, and when it is determined that there is a request for the process of reconstructing stored data which process accompanies replacement of a faulty part.
